(19) United States
(12) Patent Application Publication
(10) Pub. No.: US 2007/0215187 A1
(43) Pub. Date: Sep. 20, 2007

(54) Dishwasher Having A Height-Adjustable Upper Rack

(75) Inventors: Stephan Koch, Detmold (DE); Stephan Lange, Lemgo (DE); Ulrich Hettenhausen, Bielefeld (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/568,666

(22) PCT Filed: Apr. 20, 2005
(86) PCT No.: PCT/EP05/04203

§ 371 Date: Nov. 3, 2006

(30) Foreign Application Priority Data
May 3, 2004 (DE) 10 2004 022 025.5

(51) Int. Cl. B08B 3/00; B08B 3/12

(52) U.S. Cl. 134/56 D; 134/198; 134/58 D

(57) ABSTRACT

A dishwasher includes a washing tub, a height-adjustable upper rack, and a spray arm disposed on the upper rack. A stationary liquid conduit disposed in the washing tub supplies the spray arm with wash water, the liquid conduit having a portion extending from the sidewall. A feed tube member including a funnel opening is disposed on the upper rack and is connected to the spray arm. A coupling element engages the feed tube member via the funnel opening at a rear of the rack when the rack is inserted in the washing tub. The coupling element includes a pivoting tube having a first end operatively connected to the portion of the liquid conduit and a second end including a right-angled tube end portion extending toward the funnel opening.

The present invention relates to a dishwasher having a height-adjustable upper rack on which are mounted a spray arm and a feed tube member leading to the spray arm, the feed tube member being engaged via a funnel opening with a pivoting coupling element at the rear of the rack when the rack is inserted in the washing tub, the coupling element in turn being operatively connected to a stationary liquid conduit in the washing tub for supplying the spray arm with wash water.

Document DE 27 32 540 C2, for example, discloses a height-adjustable upper rack having a feed tube member extending at the bottom of the rack and cooperating with a spray arm disposed under the rack. In order to couple the feed tube member to the stationary liquid conduit emerging from the rear wall of the washing tub, an S-shaped pipe connector member is provided which is pivotally connected to the feed tube member. Coupling of the S-shaped coupling element is accomplished by a funnel portion formed at one end thereof, said funnel portion being operatively engaged with the stationary liquid conduit end when inserting the rack. In this prior art coupling element, there is no automatic height adjustment of the coupling element when changing the height of the rack. The height of the coupling point must be changed manually in an additional step. When, in this prior art embodiment, the rack is placed at a different level, it is therefore necessary to adjust the S-shaped pipe bend accordingly to allow for aligned coupling.

Document DE 27 32 665 C2 discloses another prior art embodiment which, in principle, overcomes the above-described disadvantages of document DE 27 32 540 C2 by means of a centering device in the form of a funnel, which is disposed on one end of the feed tube member and cooperates with an elbow pivotally mounted to the stationary liquid conduit. Thus, the elbow is adjusted according to the change in the vertical position of the rack, thereby enabling fluid passage at different vertical positions. In this prior art embodiment, it is considered disadvantageous that the angle of inclination of the coupling elbow varies very strongly because the joint is located near the coupling point. This type of coupling produces a large angular offset between the tube end piece at the rear wall and the funnel tube in the rack even in the case of a small height adjustment of the rack. Because of this, providing a sealed junction between the two parts is problematic.

It is, therefore, an object of the present invention to provide, in a dishwasher having a height-adjustable upper rack of the type mentioned at the outset, a junction between the stationary liquid conduit and the feed tube member for the spray arm, which will overcome the disadvantages described and which will avoid, in particular, long water paths, loss of space in the rack, and a limited rack height adjustment range.

This object is achieved according to the present invention by the feature of claim 1. Advantageous embodiments and refinements of the present invention will become apparent from the following dependent claims.

The advantages that can be achieved with the present invention are that the increased distance between the pivot point and the coupling point of the pivoting tube leads to small angular changes, thus allowing for stepless height adjustment over a wide range, without any movable parts being located in the area of the rack and affecting the area for placing items. Moreover, bringing the liquid conduit out of the side wall makes it possible to provide a short path for the wash water. The tube positioned at the wall of the washing tub can be pivoted together with its tube end piece. Because the axis of rotation is shifted to the side wall, no angular offset will occur between the tube end piece and the funnel tube in any of the rack positions, which considerably facilitates the coupling process. This allows the system to be used for a much wider height adjustment range

The offset between the tube end piece and the funnel tube in the horizontal direction, which is caused by the pivoting motion, is kept very low. For one thing, due to the large distance of the pivot point from the coupling point, even the smallest angular changes of the pivoting tube are sufficient to achieve a relatively large adjustment. Secondly, the pivoting tube is positioned such that it is horizontal when in the central position. Thus, the pivoting range is divided into a range above and a range below the central position, whereby the maximum lateral deflection is halved.

In accordance with the present invention, in order to provide secure and stable support for the pivoting tube, the pivoting tube is attached to the rear wall of the spraying tub by a kind of connecting link guide. Moreover, it is advantageous if the frictional force between the pivoting tube and its support in the region of the liquid conduit and in the region of the rear wall is greater than the weight of the pivoting tube. This ensures that the pivoting tube remains in position when no rack adjustment is made, which, in turn, reduces the friction between the coupling elements, and thus, the wear and tear.

In the connection area between the end of the pivoting tube and the stationary liquid conduit, there is advantageously provided a spherical joint which, in addition to the pivoting motion, allows for some translational motion of the pivoting tube with respect to the rear wall of the washing tub. This makes it possible, in particular, to prevent the coupling process from being hindered by a pivoting arc motion. Moreover, by using a spherical joint, it is also possible to compensate for manufacturing tolerances of the washing tub wall in the pull-out direction of the rack.

The liquid conduit has formed on its end portion a circumferential bead which sealingly cooperates with the attached end portion of the pivoting tube. Thus, it is obvious that when pivoting the pivoting tube, the spherical joint type of connection compensates for the resulting arc by some compensating translational movement taking place in the spherical joint. The bead is advantageously formed as a spherical segment.

It has proven to be particularly advantageous if the funnel opening of the feed tube member is designed such that its insertion slopes are asymmetrical with respect to the centerline of the tube axis and if the tube end piece is provided with an insertion slope which is preferably formed by an outlet opening extending at an angle of 50 degrees to 60 degrees. Thus, the lower insertion slope of the funnel opening can be shortened in length while maintaining the cross-sectional area of the funnel opening, thereby avoiding contact with the spray arm mounted under the rack. This, in turn, allows for maximum length of the spray arm. Moreover, the vertical distance between the feed tube member and the spray arm can be kept low, which ensures a large useful height for the lower rack.

An exemplary embodiment of the present invention is shown in the drawings in a purely schematic way and will be described in more detail below. In the drawing,

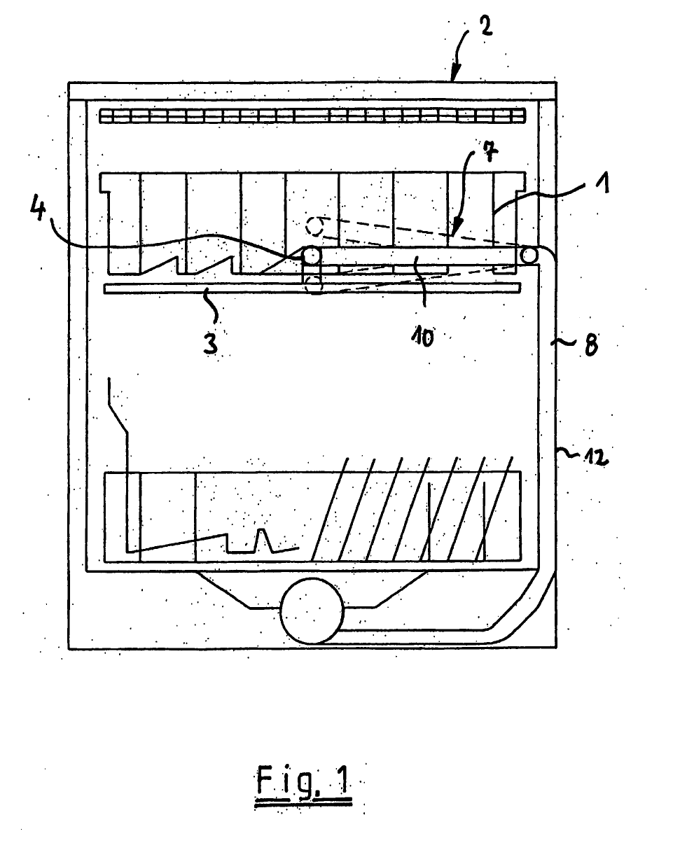

FIG. 1 is a cross-sectional front view of a dishwasher;

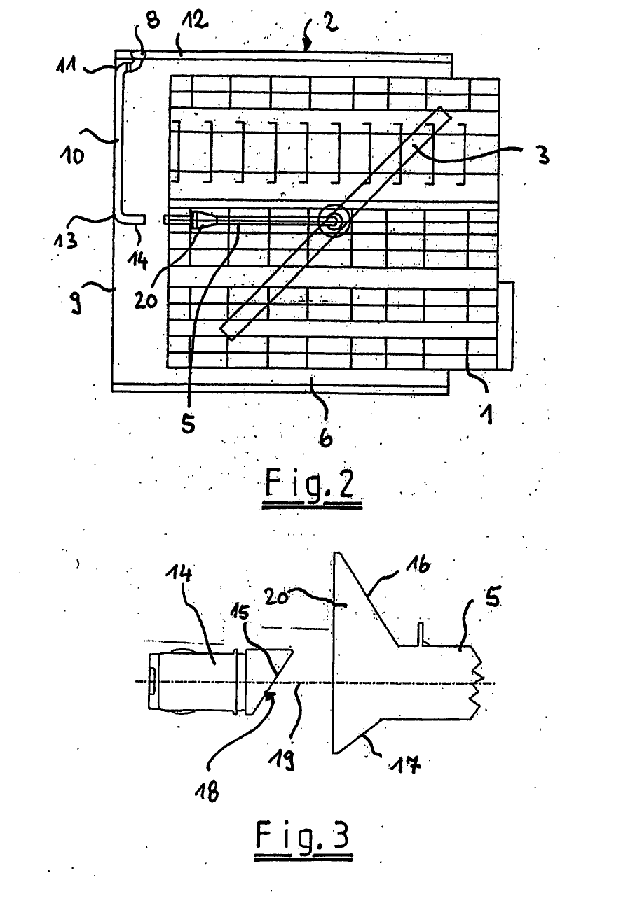

FIG. 2 is a top view of a height-adjustable upper rack;

FIG. 3 is an isolated view showing the coupling point between the funnel opening and the tube end piece;

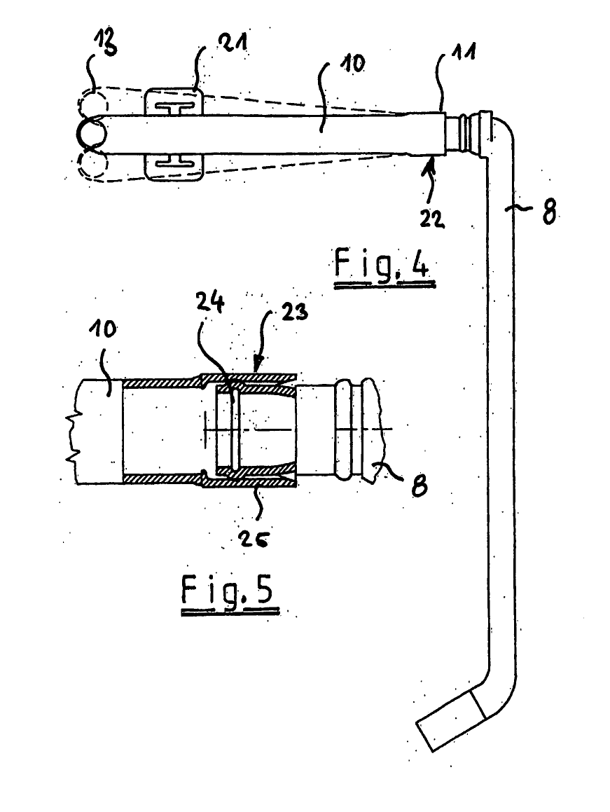

FIG. 4 is an isolated view showing the pivoting tube cooperatively connected to the stationary liquid conduit; and

FIG. 5 is a cross-sectional view of the spherical joint between the pivoting tube and the liquid conduit.

FIG. 1 is a schematic view showing a height-adjustable upper rack 1 of a dishwasher 2, including a spray arm 3 rotatably disposed under the upper rack and a feed tube member 5 extending at the bottom rack 4, better shown in FIG. 2. When rack 1 is inserted in washing tub 6, feed tube member 5 is engaged with a height-compensating coupling element 7, which in turn is operatively connected to a stationary liquid conduit 8 in washing tub 6 for supplying spray arm 3 with wash water.

Coupling element 7, better shown in FIG. 4, includes a pivoting tube 10 which is attached to rear wall 9 of washing tub 6 and preferably extends across half of rear wall 9 and whose one end 11 is connected to stationary liquid conduit 8, which emerges from side wall 12 of washing tub 6. At its other end 13, there is integrally formed a tube end piece 14 which forms a right angle and which, by means of corresponding insertion slopes 15, 16, 17, adjusts pivoting tube 10 to the actual height of the rack 1 for supplying spray arm 3 with wash water. The corresponding orientations can be better seen in FIG. 1 and in FIG. 4, where the corresponding vertical positions of tube end piece 14 are indicated by dot-dash lines.

The detail view of FIG. 3 illustrates how the individual insertion slopes 15, 16, 17 operatively engage with each other when rack 1 is inserted into washing tub 6. An insertion slope 15, for example, is preferably provided by an outlet opening 18 at tube end piece 14, said outlet opening extending at an angle of 50 to 60 degrees and cooperating with a funnel opening 20 which is formed at the feed tube member 5 asymmetrically with respect to the centerline 19 of the tube axis and provided by the corresponding insertion slopes 16 and 17. As can be seen from FIG. 3, insertion slope 16 located above centerline 19 preferably extends at an angle of 50 to 60 degrees, while insertion slope 17 located below centerline 19 preferably extends at an angle of 30 to 40 degrees. If, for example, tube end piece 14 is now located above centerline 19, then the top edge of slope 15 cooperates with insertion slope 16. If tube end piece 14 is located below centerline 19, then the end portion of slope 15 of tube end piece 14 cooperates with insertion slope 17 located below centerline 19. If upper rack 1 is in the center position, then this provides for aligned docking of tube end piece 14. In this manner, secure docking is ensured in different positions of tube end piece 14 at all times.

FIG. 4 shows pivoting tube 10 in an isolated view, the dashed-line representations illustrating the orientations of the pivoting tube and its tube end piece 14 corresponding to the three positions relative to centerline 19 that are possible here. As can be seen in the isolated view, pivoting tube 10 is attached to rear wall 9 of washing tub 6 by a kind of connecting link guide 21. This gives the pivotally mounted tube a stable position, which also increases the reliability of coupling.

In accordance with one particularly advantageous embodiment of coupling element 7, a spherical joint 23 is provided in the connection area 22 between end 11 of pivoting tube 10 and stationary liquid conduit 8, as can be seen more clearly in the exposed view of FIG. 5. This spherical joint 23 also allows for some translational motion of pivoting tube 10 at rear wall 9 of washing tub 6. Liquid conduit 8 has formed on its end portion a circumferential bead 24 which is formed as a spherical segment and sealingly cooperates with the attached end portion 11 of pivoting tube 10. If pivoting tube 10 is now pivoted above or below centerline 19 as a result of the insertion of rack 1, then the attached end portion 25 of pivoting tube 10 migrates on circumferential bead 10 because of the positive guidance of pivoting tube 10. Spherical joint 23 is elastic, at least in the region of bead 24, in order to provide an adequate seal.

Instead of using spherical joint 23, pivoting tube 10 may also be fixedly coupled to liquid conduit 8, in which case the elasticity of the tube is used for the pivoting process during the height adjustment of the upper rack. This variant may also eliminate the need for a guiding means at rear wall 9 of washing tub 6.

1-8. (canceled)

9. A dishwasher comprising:
a washing tub;
a height-adjustable upper rack;
a spray arm disposed on the upper rack;
a stationary liquid conduit configured to supply the spray arm with wash water, the liquid conduit being disposed in the washing tub at a sidewall thereof and having a portion extending from the sidewall;
a feed tube member disposed on the upper rack and operatively connected to the spray arm, the feed tube member including a funnel opening; and
a coupling element configured to engage the feed tube member via the funnel opening at a rear of the rack when the rack is inserted in the washing tub, the coupling element including a pivoting tube having a first end operatively connected to the portion of the liquid conduit and a second end including an at least approximately right-angled tube end portion extending toward the funnel opening.

10. The dishwasher as recited in claim 9 wherein the pivoting tube extends across half of the rear wall.

11. The dishwasher as recited in claim 9 wherein the pivoting tube is attached to the rear wall of the washing tub by a connecting link guide.

12. The dishwasher as recited in claim 11 wherein a frictional force supporting the pivoting tube is greater than the weight of he pivoting tube.

13. The dishwasher as recited in claim 12 wherein the frictional force is between the pivoting tube and a region of the liquid conduit and a region of the rear wall.

14. The dishwasher as recited in claim 9 further comprising a frictional joint disposed in a connection area between the first end of the pivoting tube and the portion of liquid conduit, the spherical joint being configured to allow for some translational motion of the pivoting tube with respect to a rear wall of the washing tub.

15. The dishwasher as recited in claim 14 wherein the portion of the liquid conduit includes a circumferential bead at an end, thereof, the circumferential bead being configured to sealingly cooperate with the first end of the pivoting tube.

16. The dishwasher as recited in claim 15 wherein the circumferential bead includes a spherical segment.

17. The dishwasher as recited in claim 9 wherein the funnel opening of the feed tube member includes a first and a second insertion slope, the first and second insertion slopes being asymmetrical with respect to a centerline of the feed tube member, and wherein the tube end portion includes a third insertion slope.

18. The dishwasher as recited in claim 17 wherein the third insertion slope is formed by an outlet opening of the tube end portion, the outlet opening extending at an angle of from 50 to 60 degrees.

19. The dishwasher as recited in claim 17 wherein the first insertion slope is disposed above the centerline of the tube and extends at an angle of from 50 to 60 degrees, and the second insertion slope is disposed below the centerline of the tube and extends at an angle of from 30 to 40 degrees.
